(19) United States
(12) Patent Application Publication
(10) Pub. No.: US 2024/0300544 A1
(43) Pub. Date: Sep. 12, 2024

(54) DRIVER MONITORING DEVICE, DRIVER MONITORING METHOD, AND NON-TRANSITORY RECORDING MEDIUM

(71) Applicant: TOYOTA JIDOSHA KABUSHIKI KAISHA, Toyota-shi (JP)

(72) Inventors: Jiro FUJINO, Tokyo-to (JP); Kenichiroh HARA, Yokohama-shi (JP)

(73) Assignee: TOYOTA JIDOSHA KABUSHIKI KAISHA, Toyota-shi (JP)

(21) Appl. No.: 18/383,206

(22) Filed: Oct. 24, 2023

(30) Foreign Application Priority Data
Mar. 7, 2023 (JP) 2023-034865

(51) Int. Cl. B60W 60/00; B60Q 9/00; G06V 20/59

(52) U.S. Cl. CPC B60W 60/0053; B60Q 9/00; G06V 20/597; B60W 2420/403

(57) ABSTRACT

The driver monitoring device includes a judgment part configured to judge whether a driver of a vehicle is in a drive ready state in which the driver can perform driving operations; and a notification part configured to issue a warning to the driver when it is judged that the driver is not in the drive ready state. The judgment part is configured to acquire an image generated by an imaging device provided at the vehicle so as to capture the driver and driver information acquired by a terminal able to be operated by the driver, and judge whether the driver is in the drive ready state based on the image and the driver information.

### FIELD

The present disclosure relates to a driver monitoring device, a driver monitoring method, and a non-transitory recording medium.

### BACKGROUND

PTL 1 describes that in a vehicle provided with an automated driving function, an information device is made to issue a warning to a driver if it is judged that actions other than allowable actions permitted to the driver at the time of operation of the automated driving function are continuing to be performed by the driver.

PTL 2 describes that when judging whether the driver is in a state in which it is difficult to drive, it is judged that a driver is in the state in which it is difficult to drive if an abnormality of at least one of a driving operation by the driver and a running state of the vehicle is detected in addition to abnormalities in the state of the driver.

PTL 3 describes detecting a state of a driver and changing a timing of notification of switching of driving modes of a vehicle (for example, switching from an automated driving mode to a manual driving mode) in accordance with the state of the driver.

PTL 4 describes that a gaze and state of a driver are monitored and if detecting that the gaze of the driver is directed to a device such as a smart phone when requesting the driver take over with a manual driving mode from an automated driving control mode, the function of that device is stopped.

### CITATIONS LIST

### Patent Literature

[PTL 1] Japanese Unexamined Patent Publication No. 2021-152888
[PTL 2] Japanese Unexamined Patent Publication No. 2019-166968
[PTL 3] WO2017/085981
[PTL 4] Japanese Unexamined Patent Publication No. 2021-049891

### SUMMARY

### Technical Problem

When level 3 automated driving is being performed in a vehicle, operation of a terminal such as a smart phone by a driver is allowed so long as the driver is in a state enabling him to take over driving operations in response to a request from the system. On the other hand, actions which would obstruct quick takeover of driving operations such as dozing off are prohibited.

For this reason, even when level 3 automated driving is being performed, it is necessary to use an imaging device provided in the vehicle to capture the driver so as to monitor the state of the driver. However, it is difficult to differentiate a state where the driver is operating a terminal from the driver nodding off or being in an abnormal posture due to sudden illness based on an image generated by such an imaging device. For this reason, when the driver is operating the terminal, it is liable to be mistakenly judged that the driver is not in a drive ready state in which the driver can perform driving operations.

Therefore, in consideration of the above technical issues, an object of the present disclosure is to keep from mistakenly judging that a driver is not in a drive ready state in which the driver can perform driving operations.

### Solution to Problem

The summary of the present disclosure is as follows.
(1) A driver monitoring device comprising a processor configured to: judge whether a driver of a vehicle is in a drive ready state in which the driver can perform driving operations; and issue a warning to the driver when it is judged that the driver is not in the drive ready state, wherein the processor is configured to acquire an image generated by an imaging device provided at the vehicle so as to capture the driver and driver information acquired by a terminal able to be operated by the driver, and judge whether the driver is in the drive ready state based on the image and the driver information.
(2) The driver monitoring device described in above (1), wherein the driver information includes an image generated by a camera mounted at the terminal or information input by the driver to the terminal.
(3) The driver monitoring device described in above (1) or (2), wherein the processor is configured to judge whether the driver is in a drive ready state based on the image by a predetermined judgment criteria, judge whether the driver is in an awake state based on the driver information, and ease the judgment criteria when judging the driver is in the awake state.
(4) The driver monitoring device described in above (1) or (2), wherein the processor is configured to judge whether the driver is in the drive ready state based on the image by a predetermined judgment criteria and, judge whether the driver is in an awake state based on the driver information when judging that the driver is not in the drive ready state based on the image, and, invalidate a result of judgment based on the image when judging that the driver is in the awake state.
(5) The driver monitoring device described in any one of above (1) to (4), wherein the processor is configured to acquire driver information from the terminal when judging that the driver is not in the drive ready state based on the image, and not acquire driver information from the terminal when judging that the driver is in the drive ready state based on the image.
(6) The driver monitoring device described in any one of above (1) to (5), wherein the processor is configured to limit or prohibit operation of the terminal by the driver when level 2 or lower automated driving is being performed at the vehicle.
(7) The driver monitoring device described in any one of above (1) to (6), wherein the terminal is a smart phone.
(8) A driver monitoring method performed by a computer, comprising: acquiring an image generated by an imaging device provided at a vehicle so as to capture a driver of the vehicle; acquiring driver information acquired by a terminal able to be operated by the driver; judging whether the driver is in a drive ready state in which the driver can perform driving operations based on the image and the driver information; and issuing a warning to the driver if it is judged that the driver is not in the drive ready state.
(9) A non-transitory recording medium having recorded thereon a computer program, the computer program causing a computer to: acquire an image generated by an imaging device provided at a vehicle so as to capture a driver of the vehicle; acquire driver information acquired by a terminal able to be operated by the driver, judge whether the driver is in a drive ready state in which the driver can perform driving operations based on the image and the driver information; and issue a warning to the driver if it is judged that the driver is not in the drive ready state.

According to the present disclosure, it is possible to keep from mistakenly judging that a driver is not in a drive ready state in which the driver can perform driving operations.

### BRIEF DESCRIPTION OF DRAWINGS

FIG. 1 is a schematic view of the configuration of a vehicle control system including a driver monitoring device according to a first embodiment of the present disclosure.

FIG. 2 is a view schematically showing an inside of a vehicle at which a driver monitor camera is provided.

FIG. 3 is a functional block diagram of a processor of an ECU in the first embodiment.

FIG. 4 is a flow chart showing a control routine of processing for setting judgment criteria in the first embodiment of the present disclosure.

FIG. 5 is a flow chart showing a control routine of warning processing in the first embodiment of the present disclosure.

FIG. 6 is a flow chart showing a control routine of warning processing in a second embodiment of the present disclosure.

FIG. 7 is a functional block diagram of a processor of an ECU in a third embodiment.

FIG. 8 is a flow chart showing a control routine of processing for judging terminal operation in the third embodiment of the present disclosure.

### DESCRIPTION OF EMBODIMENTS

Below, referring to the drawings, embodiments of the present disclosure will be explained in detail. Note that, in the following explanation, similar component elements are assigned the same reference signs.

### First Embodiment

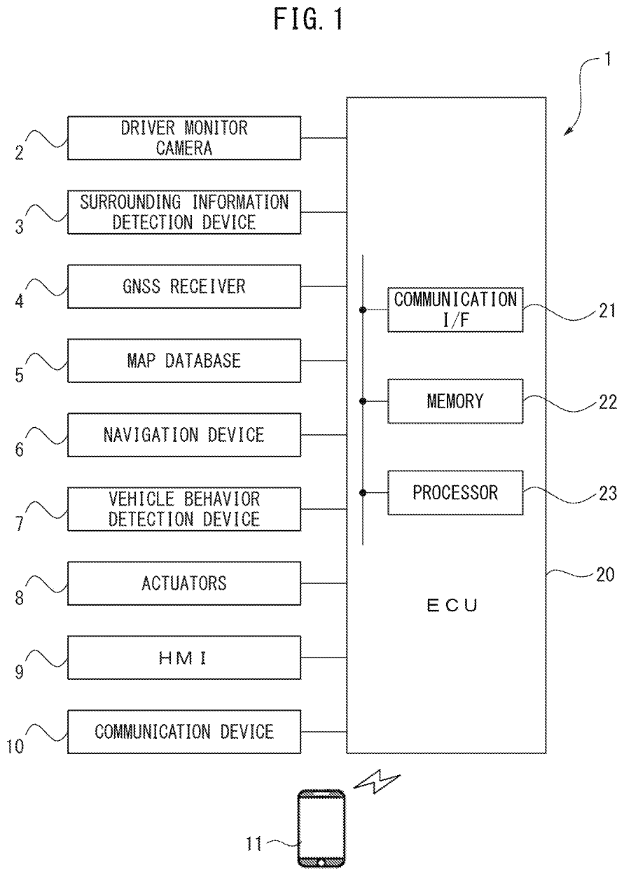

Hereinafter, a first embodiment of the present disclosure will be described referring to FIG. 1 to FIG. 5. FIG. 1 is a schematic view of the configuration of a vehicle control system 1 including a driver monitoring device according to a first embodiment of the present disclosure. The vehicle control system 1 is mounted on a vehicle and executes various types of control of the vehicle.

As shown in FIG. 1, the vehicle control system 1 includes a driver monitor camera 2, a peripheral information detection device 3, a GNSS (Global Navigation Satellite System) receiver 4, a map database 5, a navigation device 6, a vehicle behavior detection device 7, actuators 8, a human machine interface (HMI) 9, a communication device 10 and an electronic control unit (ECU) 20. The driver monitor camera 2, the peripheral information detection device 3, the GNSS receiver 4, the map database 5, the navigation device 6, the vehicle behavior detection device 7, the actuators 8, the HMI 9 and the communication device 10 are electrically connected to the ECU 20 via an in-vehicle network compliant with standards such as CAN (Controller Area Network), etc.

The driver monitor camera 2 captures the driver of the vehicle and generates an image representing the driver. The output of the driver monitor camera 2, i.e., the image generated by the driver monitor camera 2, is transmitted to the ECU 20. A specific example of the configuration of the driver monitor camera 2 will be described below.

The driver monitor camera 2 has a camera and a projector. The camera is comprised of a lens and an imaging element and is for example a CMOS (complementary metal oxide semiconductor) camera or a CCD (charge coupled device) camera. The projector is an LED (light emitting diode) and for example includes two near infrared LEDs arranged at the two sides of the camera. By firing near infrared light at a driver, it is possible to capture an image of the driver without irritating the driver even at night time and other times of low illumination. Further, a bandpass filter for removing light of a wavelength component other than the near infrared may be provided at the inside of the camera, while a visible light cut filter for removing light of a red wavelength component emitted from a near infrared LED may be provided at the front surface of the projector.

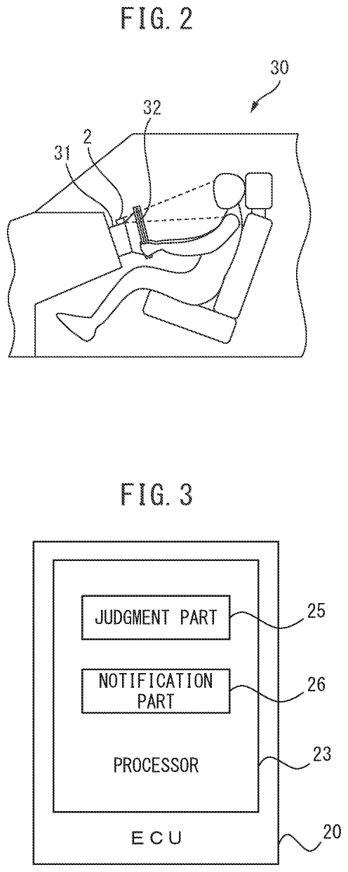

FIG. 2 is a view schematically showing an inside of a vehicle 30 at which the driver monitor camera 2 is provided. The driver monitor camera 2 is provided at the inside of the passenger compartment of the vehicle 30 so as to capture an image of the driver of the vehicle 30. For example, as shown in FIG. 2, the driver monitor camera 2 is provided at the top part of a steering column 31 of the vehicle 30. FIG. 2 shows the range of projection of the driver monitor camera 2 by broken lines. In the present embodiment, the driver monitor camera 2 captures a face of the driver. Note that, the driver monitor camera 2 may be provided at a steering wheel 32, a room mirror, an instrument panel, an instrumentation hood, etc., of the vehicle 30. The driver monitor camera 2 is one example of an imaging device provided at the vehicle so as to capture a face of a driver.

The peripheral information detection device 3 acquires data (images, point cloud data, etc.) around the vehicle 30 and detects peripheral information (for example, peripheral vehicles, lanes, pedestrians, bicycles, traffic lights, signs, etc.) of the vehicle 30. For example, the peripheral information detection device 3 includes a camera (monocular camera or stereo camera), a millimeter-wave radar, a LIDAR (Laser Imaging Detection And Ranging) or an ultrasonic sensor (sonar), or any combination thereof. Note that the peripheral information detection device 3 may further include an illuminance sensor, a rain sensor, etc. The output of the peripheral information detection device 3, i.e., the peripheral information of the vehicle 30 detected by the peripheral information detection device 3 is transmitted to the ECU 20.

The GNSS receiver 4 detects the present position of the vehicle 30 (for example, the latitude and longitude of the vehicle 30) based on positioning information obtained from a plurality of (for example, three or more) positioning satellites. Specifically, the GNSS receiver 4 captures a plurality of positioning satellites and receives radio waves transmitted from the positioning satellites. Then, the GNSS receiver 4 calculates the distance to each of the positioning satellites based on the difference between the transmission time and the reception time of the radio wave, and detects the present position of the vehicle 30 based on the distance to the positioning satellite and the position (orbit information) of the positioning satellite. The output of the GNSS receiver 4, i.e., the present position of the vehicle 30 detected by the GNSS receiver 4, is transmitted to the ECU 20. The GPS (Global Positioning System) receiver is an example of the GNSS receiver.

The map database 5 stores map information. The ECU 20 acquires map information from the map database 5. Note that the map database may be provided at the outside of the vehicle 30 (for example, a server etc.), and the ECU 20 may acquire map information from the outside of the vehicle 30.

The navigation device 6 sets a driving route of the vehicle 30 to the destination based on a current position of the vehicle 30 detected by the GNSS receiver 4, map information of the map database 5, input by occupants of the vehicle 30 (for example, the driver), etc. The driving route set by the navigation device 6 is sent to the ECU 20.

The vehicle behavior detection device 7 detects behavior information of the vehicle 30. The vehicle behavior detection device 7 includes, for example, a vehicle speed sensor for detecting the speed of the vehicle 30, a yaw rate sensor for detecting a yaw rate of the vehicle 30, etc. The output of the vehicle behavior detection device 7, that is, the behavior information of the vehicle detected by the vehicle behavior detection device 7, is sent to the ECU 20.

The actuators 8 enable the vehicle 30 to operate. For example, the actuators 8 include drive devices for acceleration of the vehicle 30 (for example, at least one of an internal combustion engine and an electric motor), a brake actuator for braking (decelerating) the vehicle 30, a steering actuator for steering the vehicle 30, etc. The ECU 20 controls the actuators 8 to control the behavior of the vehicle 30.

The HMI 9 transmits information between the vehicle 30 and occupants of the vehicle 30 (for example, the driver). The HMI 9 has an output part for providing information to the occupants of the vehicle 30 (for example, a display, a speaker, a light source, a vibration unit, etc.) and an input part to which information is input by occupants of the vehicle 30 (for example, a touch panel, operating buttons, operating switches, microphone, etc.) The output of the ECU 20 is notified to the occupants of the vehicle 30 through the HMI 9, while the input from the occupants of the vehicle 30 is sent through the HMI 9 to the ECU 20. The HMI 9 is one example of an input device, an output device, or an input/output device.

The communication device 10 can communicate with the outside of the vehicle 30 and enables communication between the vehicle 30 and the outside of the vehicle 30. For example, the communication device 10 includes a wide area wireless communication module enabling wide area wireless communication between the vehicle 30 and the outside of the vehicle 30 (for example, a server) through a communication network such as a carrier network and the Internet, and a short range wireless communication module enabling short range wireless communication based on a communication standard such as Bluetooth® or ZigBee®.

On the other hand, the terminal 11 shown in FIG. 1 is held by the driver of the vehicle 30. The terminal 11 is brought into the vehicle 30 by the driver and can be operated by the driver. The terminal 11 is paired in advance with the vehicle 30. The ECU 20 can communicate with the terminal 11 through the short range wireless communication module of the communication device 10. In the present embodiment, the terminal 11 is a smart phone. Note that, the terminal 11 may be electrically connected with the ECU 20 by a cable.

The ECU 20 performs various controls of the vehicle. As shown in FIG. 1, the ECU 20 includes a communication interface 21, a memory 22 and a processor 23. The communication interface 21 and the memory 22 are connected to the processor 23 via signal lines. In the present embodiment, one ECU 20 is provided, but a plurality of ECUs may be provided for each function.

The communication interface 21 has an interface circuitry for connecting the ECU 20 to the in-vehicle networking. The ECU 20 is connected to other in-vehicle devices via the communication interface 21.

The memory 22 includes, for example, a volatile semiconductor memory and a non-volatile semiconductor memory. The memory 22 stores programs, data, etc., used when various kinds of processing are executed by the processor 23.

The processor 23 includes one or more CPU (Central Processing Unit) and its peripheral circuitry. Note that the processor 23 may further include an arithmetic circuit such as a logical arithmetic unit or a numerical arithmetic unit.

The vehicle control system 1 functions as an automated driving system and realizes autonomous driving of the vehicle 30. In the present embodiment, the vehicle control system 1 can perform level 3 automated driving in a preset operational design domain (ODD). Note that the automated driving levels in this Description are based on definitions of the SAE (Society of Automotive Engineers) J3016.

The vehicle control system 1 performs level 2 or lower automated driving under conditions other than a preset operational design domain. In level 1 or level 2 automated driving, the vehicle control system 1 activates driver assist functions such as adaptive cruise control (ACC) for automatically controlling the speed of a vehicle in accordance with whether or not there is a preceding vehicle, and lane keeping assist (LKA) or lane tracing assist (LTA) for automatically controlling steering of a vehicle so that the vehicle be kept in its lane. Level 0 automated driving corresponds to manual driving in which all of the acceleration, deceleration (braking), and steering of the vehicle 30 are performed by the driver.

On the other hand, in level 3 automated driving, the system mainly performs the driving operations of the vehicle 30. The driver is freed from his duty to monitor the surroundings. Therefore, when level 3 automated driving is performed at the vehicle 30, so long as the state is one where a driving operation can be taken over in response to a request from the system, operation of the terminal 11 by the driver is permitted. On the other hand, actions which would obstruct quick takeover of driving operations such as dozing off are prohibited. For this reason, even if level 3 automated driving is being performed, it is necessary to use an imaging device such as the driver monitor camera 2 to monitor the state of the driver.

In the present embodiment, the ECU 20 provided at the vehicle 30 functions as the driver monitoring device monitoring the driver of the vehicle 30. FIG. 3 is a functional block diagram of the processor 23 of the ECU 20 in the first embodiment. In the present embodiment, the processor 23 has a judgment part 25 and a notification part 26. The judgment part 25 and the notification part 26 are function modules realized by a computer program stored in the memory 22 of the ECU 20 being run by the processor 23 of the ECU 20. Note that, these function modules may respectively be realized by dedicated processing circuits provided at the processor 23.

The judgment part 25 judges whether the driver of the vehicle 30 is in a drive ready state in which the driver can perform driving operations. In particular, in the present embodiment, the judgment part 25 judges whether the driver is in a drive ready state when level 3 automated driving is being performed at the vehicle 30. For example, the judgment part 25 judges that the driver is not in a drive ready state when the driver dozing off or leaving the seat or abnormal posture due to sudden illness is detected. The notification part 26 issues a warning to the driver when it is judged by the judgment part 25 that the driver is not in a drive ready state. Due to this, it is possible to prompt the driver to return to a drive ready state and in turn possible to enhance the safety of automated driving of the vehicle 30.

The judgment part 25 acquires an image generated by the driver monitor camera 2 (below, referred to as the “monitoring image”) and judges whether the driver is in a drive ready state based on the monitoring image. As explained above, in level 3 automated driving, the driver can operate the terminal 11 as a legitimate action while the vehicle 30 is running. However, it is difficult to differentiate a state where the driver is operating a terminal 11 from the driver dozing off or being in an abnormal posture due to sudden illness based on the monitoring image. On the other hand, the terminal 11 can acquire information different from the monitoring image as information relating to the driver.

Therefore, in addition to the monitoring image, the judgment part 25 acquires driver information acquired from the terminal 11 and judges whether the driver is in a drive ready state based on the monitoring image and the driver information. Due to this, it is possible to keep the driver from being mistakenly judged to not be in a drive ready state.

In the present embodiment, the judgment part 25 judges whether the driver is in a drive ready state based on the monitoring image by a predetermined judgment criteria. Further, the judgment part 25 judges whether the driver is in an awake state based on the driver information acquired by the terminal 11 and, when judging that the driver is in an awake state, eases the judgment criteria. Due to this, it is possible to keep a driver operating the terminal 11 as legitimate action from being mistakenly judged to not be in a drive ready state.

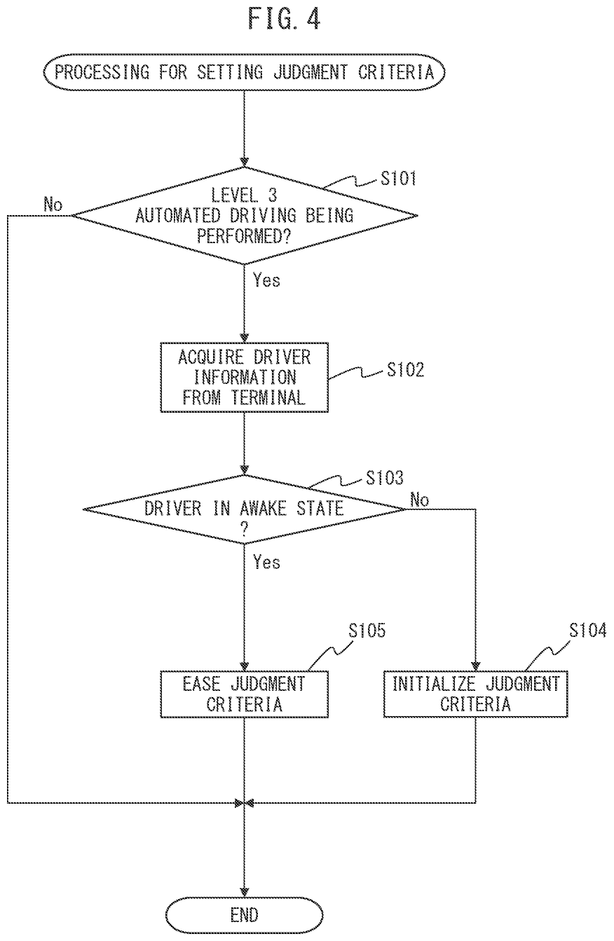

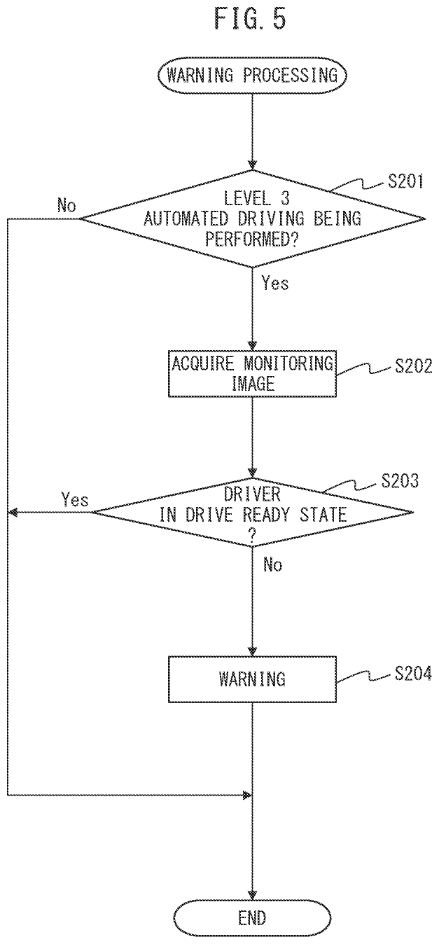

Below, referring to FIG. 4 and FIG. 5, the above-mentioned control will be explained in detail. FIG. 4 is a flow chart showing a control routine of processing for setting judgment criteria in the first embodiment of the present disclosure. This control routine is repeatedly executed at predetermined execution intervals by the processor 23 of the ECU 20.

First, at step S101, the judgment part 25 of the processor 23 judges whether level 3 automated driving is being performed at the vehicle 30. Level 3 automated driving is performed when the driver requests activation of automated driving in a preset operational design domain. If it is judged that level 3 automated driving is not being performed, the present control routine ends. On the other hand, if it is judged that level 3 automated driving is being performed, the control routine proceeds to step S102.

At step S102, the judgment part 25 acquires driver information from the terminal 11 by short range wireless communication etc. The driver information is information relating to the driver which is acquired by the terminal 11. For example, it includes an image generated by a camera mounted at the terminal 11 (for example, an internal camera) or information input by the driver into the terminal 11 (for example, information input by the driver by fingers or voice).

Next, at step S103, the judgment part 25 judges whether the driver is in an awake state based on the driver information. For example, the judgment part 25 judges whether the driver is in an awake state based on an image generated by the camera of the terminal 11 (below, referred to as “camera image”). In this case, for example, the judgment part 25 calculates the opening degree of the eyes of the driver based on the camera image, judges that the driver is in an awake state if the opening degree of the eyes is greater than or equal to a predetermined value, and judges that the driver is not in an awake state if the opening degree of the eyes is less than the predetermined value. Further, the judgment part 25 judges that it is unclear whether the driver is in an awake state if the eyes of the driver cannot be detected from the camera image.

Note that, the judgment part 25 may judge whether the driver is in an awake state based on information input by the driver to the terminal 11. In this case, the judgment part 25 judges that the driver is in an awake state if there has been input to the terminal 11 by the driver within a predetermined time period (touch input, button input, voice input, etc.) and judges that it is unclear whether the driver is in an awake state if there has been no input to the terminal 11 by the driver within a predetermined time period. Further, the judgment part 25 may judge whether the driver is in an awake state based on the camera image and information input to the terminal 11 by the driver. In this case, for example, the judgment part 25 judges that the driver is in an awake state if the opening degree of the eyes of the driver is greater than or equal to a predetermined value and input to the terminal 11 is performed by the driver within a predetermined time period. Further, the judgment part 25 may judge whether the driver is in an awake state based on the output of an acceleration sensor mounted in the terminal 11 etc.

If at step S103 it is judged that the driver is not in an awake state or it is judged that whether the driver is in an awake state is unclear, the control routine proceeds to step S104. At step S104, the judgment part 25 initializes the judgment criteria for judging whether the driver is in a drive ready state. That is, the judgment part 25 sets the judgment criteria to a preset condition. The judgment criteria is, for example, a threshold value range of the facial orientation of the driver (up-down direction and left-right direction). After step S104, the present control routine ends.

On the other hand, if at step S103 it is judged that the driver is in an awake state, the control routine proceeds to step S105. At step S105, the judgment part 25 eases the judgment criteria for judging whether the driver is in a drive ready state. That is, the judgment part 25 changes the judgment criteria so that it becomes easier for it to be judged that the driver is in a drive ready state. If the driver is operating the terminal 11 on his lap, the facial orientation of the driver becomes downward. For this reason, for example, the judgment part 25 increases the threshold value of the downward direction of the facial orientation so as to ease the judgment criteria. Further, in the monitoring image, sometimes the hand or arm of the driver holding the terminal 11 or the terminal 11 cause the eyes of the driver to be blocked. For this reason, the judgment part 25 may ease the judgment criteria so that the driver is judged to be in a driving ready state so long as the face of the driver is detected from the monitored image. After step S105, the present control routine ends.

FIG. 5 is a flow chart showing a control routine of warning processing in the first embodiment of the present disclosure. This control routine is repeatedly executed at predetermined execution intervals by the processor 23 of the ECU 20.

First, at step S201, in the same way as step S101 of FIG. 4, the judgment part 25 of the processor 23 judges whether level 3 automated driving is being performed at the vehicle 30. If it is judged that level 3 automated driving is not being performed, the present control routine ends. On the other hand, if it is judged that level 3 automated driving is being performed, the control routine proceeds to step S202.

At step S202, the judgment part 25 acquires a monitoring image. A monitoring image is repeatedly generated by the driver monitor camera 2 at predetermined capture intervals (for example 1/30 second to 1/10 second). The judgment part 25 acquires the monitoring image from the driver monitor camera 2.

Next, at step S203, the judgment part 25 judges whether the driver is in a drive ready state based on the monitoring image by a predetermined judgment criteria. For example, the judgment part 25 detects a facial orientation of the driver from the monitoring images, judges that the driver is in a drive ready state when the facial orientation of the driver is within a predetermined threshold value range, and judges that the driver is not in a drive ready state when the facial orientation of the driver is outside of the predetermined threshold value range. At this time, the judgment criteria set at step S104 or S105 is used. That is, if it is judged that the driver is in an awake state, the judgment criteria is eased.

If at step S203 it is judged that the driver is in a drive ready state, the present control routine ends. On the other hand, if at step S203 it is judged that the driver is not in a drive ready state, the control routine proceeds to step S204.

At step S204, the notification part 26 of the processor 23 issues a visual, audio, or tactile warning to the driver through the HMI 9. An example of a visual warning is a warning light emitted from a light source of the HMI 9 etc. An example of an audio warning is a warning voice or warning sound etc., output from the speaker of the HMI 9. An example of a tactile warning is vibration output from the vibration unit of the HMI 9 etc. (for example, vibration of the steering wheel 32 or seat belt). Note that, the notification part 26 may issue two or more types of warnings (for example visual warning and audio warning) to the driver. After step S204, the present control routine ends.

Note that, the control routine of FIG. 4 may be omitted and steps S102 to S105 of FIG. 4 may be performed between steps S201 and S202 of FIG. 5. Further, the judgment part 25 may also acquire driver information from the terminal 11 and judge whether the driver is in an awake state based on the driver information only if it is judged that the driver is not in a drive ready state based on the monitoring image. In this case, if the judgment part 25 judges that the driver is in an awake state, it eases the judgment criteria and uses the eased judgment criteria to again judge whether the driver is in a drive ready state based on the monitoring image. That is, the control routine of FIG. 4 may be omitted and steps S102, S103, and S105 of FIG. 4 and step S203 of FIG. 5 may be performed between steps S203 and S204 of FIG. 5. In this way, by acquiring driver information from the terminal 11 only if it is judged that the driver is not in a drive ready state, it is possible to reduce the amount of consumption of power at the terminal 11 and the ECU 20.

### Second Embodiment

The driver monitoring device according to a second embodiment is basically similar in configuration and control to the driver monitoring device according to the first embodiment except for the points explained below. For this reason, below, the second embodiment of the present disclosure will be explained focusing on parts different from the first embodiment.

In the second embodiment, the judgment part 25 judges whether the driver is in a drive ready state based on a monitoring image by a predetermined judgment criteria, and when judging that the driver is not in a drive ready state based on the monitoring image, it judges whether the driver is in an awake state based on the driver information acquired by the terminal 11. Further, when judging that the driver is in an awake state, the judgment part 25 invalidates the result of judgment based on the monitoring image and judges that the driver is in a drive ready state. Due to this, it is possible to keep a driver operating the terminal 11 as legitimate action from being mistakenly judged to not be in a drive ready state.

Further, the judgment part 25 acquires driver information from the terminal 11 when judging that the driver is not in a drive ready state based on the monitoring image and does not acquire driver information from the terminal 11 when judging that the driver is in a drive ready state based on the monitoring image. Due to this, it is possible to reduce the amount of consumption of power at the terminal 11 and the ECU 20.

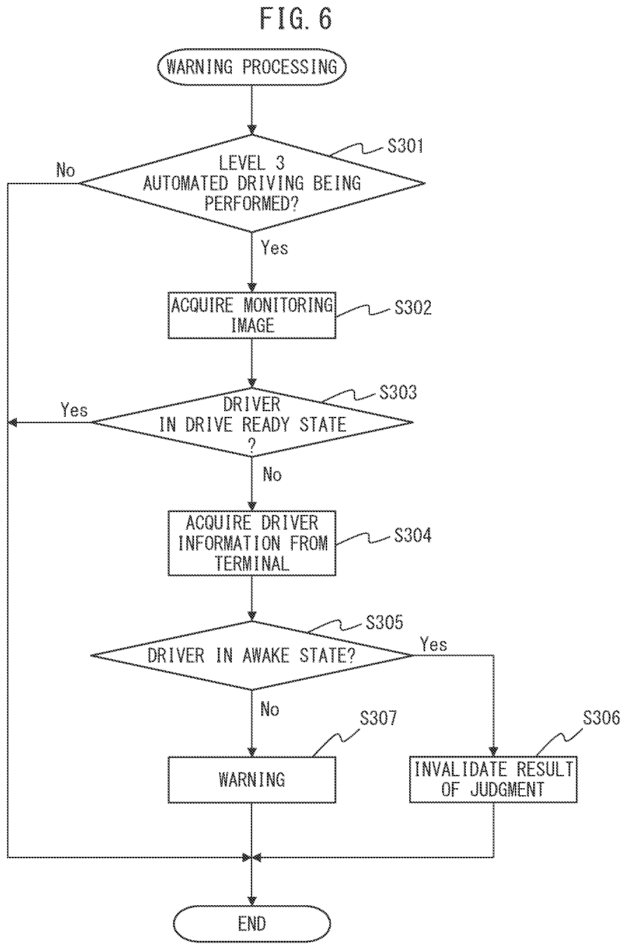

Below, referring to FIG. 6, the above-mentioned control will be explained in detail. FIG. 6 is a flow chart showing a control routine of warning processing in the second embodiment of the present disclosure. This control routine is repeatedly executed at predetermined execution intervals by the processor 23 of the ECU 20.

Steps S301 to S303 are performed in the same way as steps S201 to S203 of FIG. 5. At step S303, it is judged whether the driver is in a drive ready state based on the monitoring image by initially set judgment criteria. If at step S303 it is judged that the driver is not in a drive ready state, the control routine proceeds to step S304.

At step S304, in the same way as step S102 of FIG. 4, the judgment part 25 acquires driver information from the terminal 11. Next, at step S305, in the same way as step S103 of FIG. 4, the judgment part 25 judges whether the driver is in an awake state based on the driver information.

If at step S305 it is judged that the driver is in an awake state, the control routine proceeds to step S306. At step S306, the judgment part 25 invalidates the result of judgment based on the monitoring image. That is, the judgment part 25 judges that the driver is in a drive ready state. After step S306, the present control routine ends.

On the other hand, if at step S305 it is judged that the driver is in an awake state, the control routine proceeds to step S307. In this case, the result of judgment based on the monitoring image is maintained. For this reason, at step S307, in the same way as step S204 of FIG. 5, the notification part 26 issues a warning to the driver through the HMI 9. After step S307, the present control routine ends. Note that, step S304 may be performed between step S301 and step S303.

### Third Embodiment

The driver monitoring device according to a third embodiment is basically similar in configuration and control to the driver monitoring device according to the first embodiment except for the points explained below. For this reason, below, the third embodiment of the present disclosure will be explained focusing on parts different from the first embodiment.

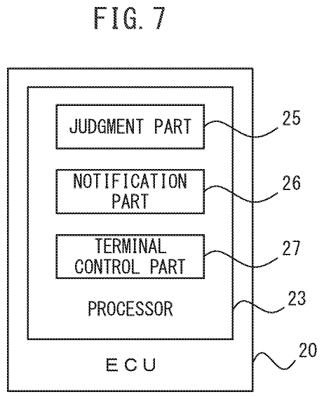

FIG. 7 is a functional block diagram of the processor 23 of the ECU 20 in the third embodiment. In the third embodiment, the processor 23 has a terminal control part 27, in addition to the judgment part 25 and the notification part 26. The judgment part 25, the notification part 26, and the terminal control part 27 are function modules realized by a computer program stored in the memory 22 of the ECU 20 being run by the processor 23 of the ECU 20. Note that, these function modules may respectively be realized by dedicated processing circuits provided at the processor 23.

The terminal control part 27 controls the terminal 11 by sending control signals to the terminal 11. In level 3 automated driving, operation of the terminal 11 by the driver is permitted, but in level 2 or lower automated driving, basically operation of the terminal 11 by the driver is not permitted. However, the driver is liable to be subjected to impulses making him want to operate the terminal 11 in level 2 or lower automated driving. This is particularly remarkable if the driver had operated the terminal 11 in level 3 automated driving.

Therefore, in the third embodiment, the terminal control part 27 limits the operation of the terminal 11 by the driver when level 2 or lower automated driving is being performed at the vehicle 30. Due to this, it is possible to keep the attention of the driver from wandering during level 2 or lower automated driving.

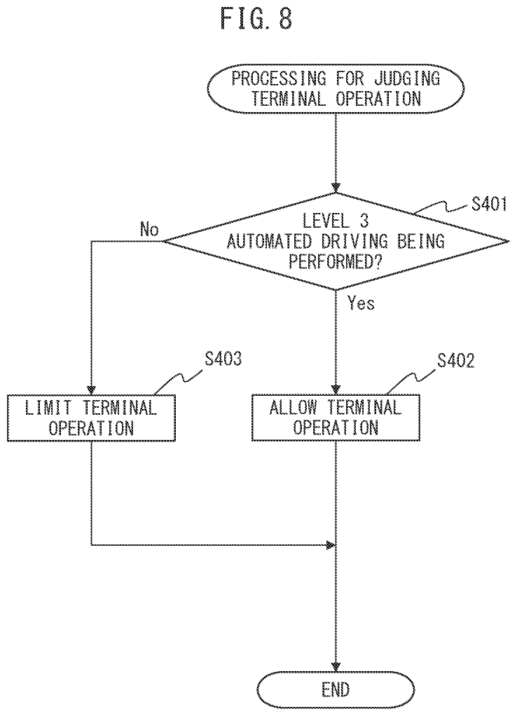

In the third embodiment, in addition to the control routines of FIG. 4 and FIG. 5, the control routine of FIG. 8 is performed. FIG. 8 is a flow chart showing a control routine of processing for judging terminal operation in the third embodiment of the present disclosure. This control routine is repeatedly executed at predetermined execution intervals by the processor 23 of the ECU 20.

First, at step S401, the terminal control part 27 of the processor 2 judges whether level 3 automated driving is being performed at the vehicle 30. If it is judged that level 3 automated driving is being performed, the control routine proceeds to step S402.

At step S402, the terminal control part 27 allows the driver to operate the terminal 11. At this time, the terminal control part 27 may send a control signal allowing operation of the terminal 11 to the terminal 11. After step S402, the present control routine ends.

On the other hand, if at step S401 it is judged that level 3 automated driving is not being performed, that is, if level 2 or lower automated driving is being performed, the control routine proceeds to step S403. At step S403, the judgment part 25 limits operation of the terminal 11 by the driver. Specifically, the judgment part 25 sends a control signal limiting operation of the terminal 11 to the terminal 11. If the terminal 11 receives the control signal, the processor of the terminal 11 performs control limiting operation of the terminal 11. The limit on operation of the terminal 11 covers, for example, operations using fingers of the driver. Operations by voice of the driver (for example, hands free talking, listening to the radio or music, etc.) are excluded from coverage by the limits. After step S403, the present control routine ends.

Note that, the terminal control part 27 may prohibit operation of the terminal 11 by the driver when level 2 or lower automated driving is being performed at the vehicle 30. In this case, at step S403, the terminal control part 27 sends a control signal prohibiting operation of the terminal 11 to the terminal 11. As a result, the processor of the terminal 11 performs control prohibiting operation of the terminal 11.

### Other Embodiments

Above, preferred embodiments according to the present disclosure were explained, but the present disclosure is not limited to these embodiments and can be corrected and changed in various ways within the language of the claims. For example, a part of the configuration of the vehicle control system 1 shown in FIG. 1 may be omitted.

Further, the terminal 11 able to be operated by the driver is not limited to a smart phone and may be another portable terminal such as a tablet terminal or a portable game machine, or the navigation device 6 provided at the vehicle 30. Further, the above control may be performed to monitor the state of the driver in a situation other than level 3 automated driving.

Further, a server provided at the outside of the vehicle 30 may function as the driver monitoring device. In this case, an image generated by an imaging device such as the driver monitor camera 2 and driver information acquired by the terminal 11 are sent through a communication network from the vehicle 30 to the server. When a judgment part of the server judges that the driver is not in a drive ready state, a notification part of the server issues a warning to the driver through the ECU 20 of the vehicle 30.

Further, a computer program for realizing the functions of the parts of the processor 23 of the ECU 20 or the processor of the server by a computer may be provided in a form stored in a computer readable recording medium. The computer readable recording medium is, for example, a magnetic recording medium, an optical recording medium, or a semiconductor memory.

Further, the above embodiments can be worked in any combinations. For example, if the second embodiment and the third embodiment are combined, in the third embodiment, the control routine of FIG. 6 is performed instead of the control routines of FIG. 4 and FIG. 5.

### REFERENCE SIGNS LIST

2. driver monitor camera
11. terminal
20. electronic control unit (ECU)
23. processor
25. judgment part
26. notification part
30. vehicle

1. A driver monitoring device comprising a processor configured to:
judge whether a driver of a vehicle is in a drive ready state in which the driver can perform driving operations; and
issue a warning to the driver when it is judged that the driver is not in the drive ready state, wherein
the processor is configured to acquire an image generated by an imaging device provided at the vehicle so as to capture the driver and driver information acquired by a terminal able to be operated by the driver, and judge whether the driver is in the drive ready state based on the image and the driver information.

2. The driver monitoring device according to claim 1, wherein the driver information includes an image generated by a camera mounted at the terminal or information input by the driver to the terminal.

3. The driver monitoring device according to claim 1, wherein the processor is configured to judge whether the driver is in a drive ready state based on the image by a predetermined judgment criteria, judge whether the driver is in an awake state based on the driver information, and ease the judgment criteria when judging the driver is in the awake state.

4. The driver monitoring device according to claim 1, wherein the processor is configured to judge whether the driver is in the drive ready state based on the image by a predetermined judgment criteria and, judge whether the driver is in an awake state based on the driver information when judging that the driver is not in the drive ready state based on the image, and, invalidate a result of judgment based on the image when judging that the driver is in the awake state.

5. The driver monitoring device according to claim 1, wherein the processor is configured to acquire driver information from the terminal when judging that the driver is not in the drive ready state based on the image, and not acquire driver information from the terminal when judging that the driver is in the drive ready state based on the image.

6. The driver monitoring device according to claim 1, wherein the processor is configured to limit or prohibit operation of the terminal by the driver when level 2 or lower automated driving is being performed at the vehicle.

7. The driver monitoring device according to claim 1, wherein the terminal is a smart phone.

8. A driver monitoring method performed by a computer, comprising:
acquiring an image generated by an imaging device provided at a vehicle so as to capture a driver of the vehicle;
acquiring driver information acquired by a terminal able to be operated by the driver;
judging whether the driver is in a drive ready state in which the driver can perform driving operations based on the image and the driver information; and
issuing a warning to the driver if it is judged that the driver is not in the drive ready state.

9. A non-transitory recording medium having recorded thereon a computer program, the computer program causing a computer to:
acquire an image generated by an imaging device provided at a vehicle so as to capture a driver of the vehicle;
acquire driver information acquired by a terminal able to be operated by the driver,
judge whether the driver is in a drive ready state in which the driver can perform driving operations based on the image and the driver information; and
issue a warning to the driver if it is judged that the driver is not in the drive ready state.
